(19) United States
(12) Patent Application Publication
(10) Pub. No.: US 2026/0208112 A1
(43) Pub. Date: Jul. 23, 2026

(54) WATER FILTER AND METHOD OF MAKING THE SAME

(71) Applicant: A. O. Smith Corporation, Milwaukee, WI (US)

(72) Inventor: Yizhi Hou, Nanjing (CN)

(21) Appl. No.: 19/158,176

(22) PCT Filed: Mar. 27, 2024
(86) PCT No.: PCT/US2024/021706

§ 371 Date: Aug. 20, 2025

Related U.S. Application Data
(60) Provisional application No. 63/493,367, filed on Mar. 31, 2023.

(51) Int. Cl. B01D 63/06; B01D 61/02; B01D 61/14; B01D 67/00; B01D 69/12; B01D 71/02; B01D 71/06

(52) U.S. Cl. CPC B01D 63/061; B01D 61/025; B01D 61/027; B01D 61/145; B01D 63/063; B01D 63/065; B01D 67/00111; B01D 69/12; B01D 71/021; B01D 71/06; B01D 2239/0407; B01D 2239/1208; B01D 2239/1241; B01D 2325/0283

(57) ABSTRACT

A method of making a water filter includes formulating a solution comprising a polymer, an adsorbent, and a first solvent, the polymer being soluble in the first solvent, casting the solution onto a substrate to form a thin film, dissolving the first solvent in a second solvent to precipitate the polymer out of solution, removing the thin film from the substrate, and rolling the thin film to form a cylindrical filter.

### CROSS-REFERENCE TO RELATED APPLICATIONS

The present application claims priority to U.S. Provisional Patent Application No. 63/493,367, filed Mar. 31, 2023, the entire contents of which are incorporated herein by reference.

### FIELD OF THE INVENTION

The present disclosure relates to a water filter and a method of making a water filter.

### BACKGROUND

Water filters constructed using activated carbon are capable of removing undesirable chemicals, disinfection byproducts for example, from drinking water. One common type of such filters is made by housing granular activated carbon (GAC) within a container. While cost-effective, such filter have generally low performance, and must be of a large size or must be replaced frequently. Another type of such filter is a carbon block filter, made by extruding or compression molding GAC with a binder. Such carbon block filters have somewhat better performance, but have increased cost and undesirably high pressure drop. Thus, there is still room for improvement.

### SUMMARY

In one embodiment, a method of making a water filter includes formulating a solution comprising a polymer, an adsorbent, and a first solvent, the polymer being soluble in the first solvent, casting the solution onto a substrate to form a thin film, dissolving the first solvent in a second solvent to precipitate the polymer out of solution, removing the thin film from the substrate, and rolling the thin film to form a cylindrical filter.

In another embodiment, a water filter includes a cylindrical inner surface, a cylindrical outer surface, and a filter body between the cylindrical inner surface and the cylindrical outer surface, the filter body consisting essentially of adsorbent bound by polymer, wherein at least 70% by weight of the adsorbent is powdered activated carbon (PAC) having a particle size of <180 μm.

Other features and aspects of the disclosure will become apparent by consideration of the following detailed description and accompanying drawings.

### BRIEF DESCRIPTION OF THE DRAWINGS

FIG. 1 is a flowchart detailing a method of making a water filter.

FIG. 2 is a schematic representation of a manufacturing apparatus for making a water filter according to one embodiment.

FIG. 3 is a schematic representation of a further manufacturing apparatus for making a water filter according to the first embodiment.

FIG. 4 is a schematic representation of a cross-section of the layers of the water filter prior to polishing via the further manufacturing apparatus illustrated in FIG. 3.

FIG. 5 is a schematic representation of a cross-section of the layers of the water filter after polishing via the further manufacturing apparatus illustrated in FIG. 3.

FIG. 6 is a schematic representation of a further manufacturing apparatus for polishing a membrane of the water filter.

FIG. 7A illustrates the water filter formed via the method of FIG. 1.

FIG. 7B illustrates an enlarged view of a portion of the water filter of FIG. 7A.

FIG. 8 is a schematic representation of a manufacturing apparatus for making a water filter according to another embodiment.

FIG. 9 is a cross-section of a first membrane having adsorbents.

FIG. 10 is a cross-section of a second membrane having adsorbents.

### DETAILED DESCRIPTION

Before any implementations of the disclosure are explained in detail, it is to be understood that the disclosure is not limited in its application to the details of construction and the arrangement of components set forth in the following description or illustrated in the following drawings. The disclosure is capable of supporting other implementations and of being practiced or of being carried out in various ways.

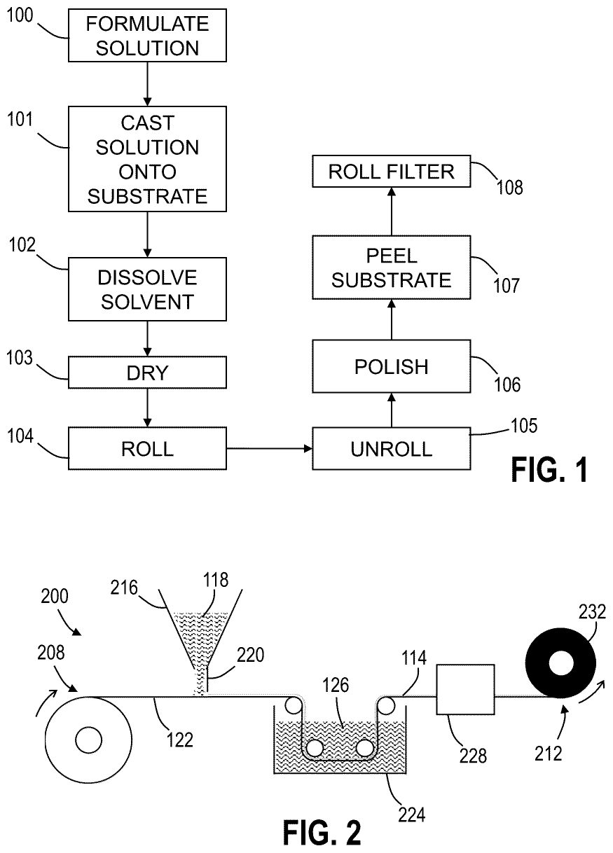

FIG. 1 illustrates a process for making a water filter 110, such as an activated carbon filter. An activated carbon filter can, as a non-limiting example, be used in water treatment to remove free chlorine, organic material, and other contaminates from water that passes through the filter. Some examples of activated carbon filters include granular activated carbon filters, carbon block filters, and activated carbon fiber filters. The method and manufacturing apparatus illustrated and described herein relates to the manufacture of activated carbon filters such as carbon block filters and produces a resultant filter 110 having an increased filter porosity which results in increased flow and increased efficiency in removing contaminates by increasing the surface area of the activated carbon in the filter 110. Additionally, the method and manufacturing apparatus 200 can be utilized to manufacture carbon filters 110 having different shapes including flat sheets filters and pleated filters.

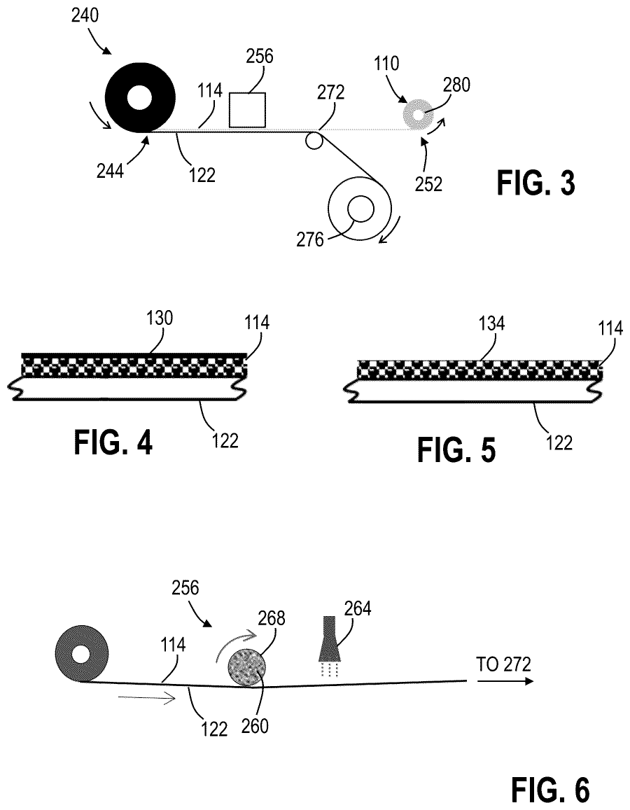

The manufacturing method includes the manufacture of a high density activated carbon membrane (HDACM) 114, as illustrated in FIG. 2, and further includes the process of forming the cylindrical carbon block filter 110 with the HDACM 114, as illustrated in FIG. 3.

The flowchart of FIG. 1 details the method steps 100-108 associated with the manufacturing process. At a first method step 100 of forming the membrane 114, a polymer is dissolved within an organic solvent. The first solvent may be n-n-dimethyl formamide, chloroform, dimethylacetamide, or n-methyl-2-pyrrolidone. The polymer may be polysulfone, polystyrene, polyether sulfone, polyvinylidene fluoride, or polyvinyl chloride.

Further at the first method step 100, an adsorbent is added to the polymer and organic solvent mixture, thereby forming an activated carbon solution 118. The ratio of adsorbent to polymer (e.g., by weight) is at least 4:1 and in some embodiments can be at least 85% adsorbent (to 15% polymer). In one embodiment, the adsorbent is activated carbon. In other embodiments, the adsorbent may be activated alumina, zeolite, ion exchange resin, or a mixture of activated carbon with the one or more of activated alumina, zeolite, and ion exchange resin.

The activated carbon (or other adsorbent) functions to remove contaminants within the membrane 114 for water purification and different adsorbents may be selected to remove specific contaminants. The activated carbon is preferably a powdered activated carbon (PAC) having a particle diameter of less than 180 microns. In contrast, traditional carbon block filters produced via manufacturing methods such as extrusion and compression molding utilized granular activated carbon (GAC) having a particle diameter of greater than 200 microns. In some embodiments, some (e.g., 5%-10%) of the adsorbent can be replaced by activated carbon fiber (or another fiber) having lengths ranging from 2 millimeters to 10 millimeters to increase the flexibility of the membrane 114.

Within the activated carbon solution 118 produced at method step 100, the polymer is provided to adhere the adsorbents together in the final water filter 110, the organic solvent is used to dissolve the polymer and provide liquidity for the solution, and the adsorbent provides the functionality of water purification of the final water filter 110 produced via the manufacturing method. The activated carbon solution 118 is provided at a temperature between 20 degrees Celsius and 80 degrees Celsius and is provided to the manufacturing apparatus 200 illustrated in FIG. 2. As shown in FIG. 2, the manufacturing apparatus 200 includes a substrate material 122 extending from a first end 208 of the manufacturing apparatus 200 to a second end 212 of the manufacturing apparatus 200 and configured to transfer the activated carbon solution 118 from the first end 208 to the second end 212. As shown, the substrate material 122 (e.g., on a roll) is provided at the first end 208 of the manufacturing apparatus 200 and a vessel 216 containing the activated carbon solution 118 is also provided at the first end 208 of the manufacturing apparatus 200. The substrate material 122 is provided as a thin sheet (e.g., having a thickness of 50-1000 microns) of, for example, a non-woven fiber, tricot, or filter paper made of polyethylene terephthalate (PET), polypropylene (PP), or polyethylene (PE). A free end of the thin sheet is attached to a motorized spool 232 at the second end 212, so that the substrate material 122 can be pulled from the roll at the first end 208 to the roll at the second end 212.

At method step 101 (FIG. 1), the activated carbon solution 118 is provided to the substrate material 122 at the first end 208 of the manufacturing apparatus 200. In some embodiments, the activated carbon solution 118 is poured onto the substrate 122 via a casting operation. A film applicator 220 (e.g., casting blade) provides an even, thin film of the mixture solution 118 onto the substrate 122 as the substrate 122 and activated carbon solution 118 move from the first end 208 of the manufacturing apparatus 200 towards the second end 212 of the manufacturing apparatus 200. In some embodiments, the casting thickness (i.e., the distance between the film applicator 220 and the substrate material 122) is between 300-4000 microns with the resultant thin film of the activated carbon solution 118 being between 300-2000 microns in thickness.

As illustrated in FIG. 2, the manufacturing apparatus 200 includes a bath tank 224 at a location between the first and second ends 208, 212. The bath tank 224 is a vessel containing a solvent 126 (i.e., a second solvent), different from the solvent (i.e., first solvent) within the activated carbon solution 118. In the embodiment shown, the second solvent 126 is water. The bath tank 224 is a water bath provided between 5 degrees Celsius and 60 degrees Celsius and configured to remove the organic solvent from the activated carbon solution 118 as the activated carbon solution 118 (on the substrate 122) passes through the bath tank 224. At method step 102 (FIG. 1), the first solvent is dissolved by moving the activated carbon solution 118 and substrate 122 through the bath tank 224. As shown in FIG. 2, the activated carbon solution 118 and substrate 122 pass through the bath tank 224 such that the substrate 122 and the activated carbon solution 118 are submerged within the solvent 126 (water) within the bath tank 224. The first solvent dissolves in the bath tank 224 to precipitate the polymer out of the solution 118, such that the polymer within the thin film coagulates, thereby adhering the activated carbon together and forming the high density activated carbon membrane 114 (HDACM).

As illustrated in FIG. 2, the manufacturing apparatus 200 includes an oven 228 located between the bath tank 224 and the second end 212 of the apparatus 200 (i.e., downstream of the bath tank 224). The substrate 122 passes through the oven 228 such that the HDACM 114 on the substrate 122 passes through the oven 228. At method step 103 (FIG. 1), the HDACM 114 is dried by passing through the oven 228. The oven 228 is set at a temperature above ambient temperature to draw away the moisture from the HDACM (from residual solvent 126 on the HDACM 114 after passing through the bath tank 224). Once dried, the substrate 122 and HDACM 114 progress to the spool 232 located at the second end 212 of the manufacturing apparatus 200. At method step 104, the HDACM 114 and the substrate 122 are rolled onto the spool 232, spirally wound about the spool 232. In some embodiments, the method step 103 of drying the HDACM 114 and the use of the oven 228 are omitted.

The roll of HDACM 114 and substrate 122 is removed from the manufacturing apparatus 200 and moved to a further manufacturing apparatus 240 as shown in FIG. 3. Mounted at a first end 244 of the apparatus 240, the HDACM 114 and substrate 122 are unrolled at step 105 (FIG. 1). A polishing system 256 is incorporated into the apparatus 240 between the first end 244 and a second end 252. At method step 106, the HDACM 114 is polished via the polishing system 256. In some embodiments, the polishing system 256 includes a polishing roller 260 and a blower 264, as shown in greater detail in FIG. 6.

As shown in FIG. 4, the HDACM 114 has an upper surface 130 (i.e., the surface opposite the substrate) with 0.1~0.5-micron pores, consisting of the polymer and resulting from the polymer having a lower density than does the adsorbent. Such pores are of a size that water can pass therethrough and larger particles (i.e., those larger than 0.1-0.5-microns) will be blocked by the membrane 114. However, the relatively small size of the pores limits the rate of water flow through the membrane 114, which would result in a high pressure drop in the water filter 110 due to the many rolled layers of HDACM 114. The polishing process eliminates the upper surface 130 of the HDACM 114, resulting in increased water flow rate through the membrane 114. The upper surface 130 of the membrane 114 is polished by the polishing roller 260, with the polishing roller 260 rotating as the HDACM 114 passes the roller 260. More specifically, the polishing roller 260 counterrotates with respect to the membrane 114 (i.e., the membrane 114 is moving to the right in FIG. 4 as the polishing roller 260 rotates clockwise above the membrane 114). The roller 260 is driven to rotate via a motor. The polishing roller 260 can have a contact surface 268 (for contacting the upper surface 130 of the HDACM 114) formed by a 500-2000 grit sandpaper or equivalent surface roughness. The relative velocity of the polishing roller 260 and the HDACM 114 (i.e., the difference between the velocity of the outer surface of the roller 260 and the velocity of the HDACM 114) is between 2 to 20 cm/s.

The blower 264 is mounted downstream of the roller 260 (i.e., between the roller 260 and the second end 252 of the apparatus 240) and blows air or water onto the HDACM 114 to remove the polished powder/debris off of the polished upper surface 134 of the HDACM 114.

The resultant polished upper surface 134 (FIG. 5) has a decreased density relative to the unpolished upper surface 130 (FIG. 4) such that water can pass through the membrane 114 more freely. The reduction in the thickness of the HDACM 114 after polishing is less than 50 microns (e.g., 5-50 microns), while the flux of the HDACM 114 increases more than 100% relative to the unpolished HDACM 114. The final thickness of the HDACM 114 (without the substrate material 122) is, in some embodiments, between 300 and 2000 microns (e.g., between 300-1000 microns, between 400-1000 microns). In some embodiments, the final thickness is at least 400 microns to limit tearing of the HDACM 114.

The polishing roller 260 can be lifted or otherwise moved away from the HDACM 114 to pause the polishing process at designated times. As such, the rolled carbon block filter 110 can, in some embodiments, be built as a partially polished filter. For example, in some embodiments the water inlet side (e.g., the outer layers 138) of the rolled membrane 114 omit the polishing step to maintain the upper surface with small pores on the outer layers 138 to remove the particles and bacteria more effectively without imposing substantial additional pressure drop through the filter. In the same embodiment, the remainder of the filter body, including the water outlet side (e.g., the inner layers 142) are polished such the pressure drop of the filter 110 is minimized. The number of unpolished layers can vary based on the bacterial removal requirements, with a higher requirement being associated with more unpolished layers. In other embodiments where the directional flow of the water through the rolled carbon block filter 110 is radially outward, the unpolished layers can be provided on the innermost layers instead.

In some embodiments, the HDACM 114 is removed from the substrate 122 and/or is polished prior to rolling the substrate 122 such that rolling and unrolling (method steps 104 and 105) are omitted. In some embodiments, the manufacturing apparatuses 200, 240 in FIGS. 2-3 are a single manufacturing apparatus while in other embodiments, the manufacturing apparatuses 200, 240 may be separate (e.g., spaced apart) from one another.

Following the polishing step, as outlined in method step 107 (FIG. 1), the substrate 122 is separated (e.g., peeled) from the HDACM, 114 as shown in FIG. 3. The manufacturing apparatus 240 includes a first spool 276 for winding the substrate 122 and a second spool 280 for winding the HDACM 114. At the separation point 272, the HDACM 114 is peeled off of the substrate 122 as each of the substrate 122 and HDACM 114 are wound about their respective spools 276, 280. Method step 108 includes rolling the filter 110, which includes rolling (i.e., spirally winding) the HDACM 114 about the spool 280 to form the final filter 110 as a rolled carbon block filter.

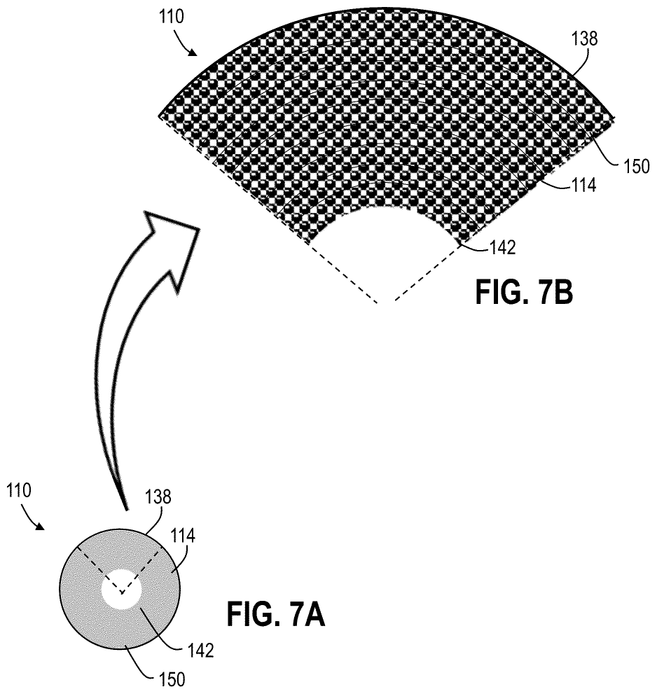

FIGS. 7A-7B illustrate the filter 110 formed by the method illustrated in FIG. 1. As shown, the filter 110 has a cylindrical inner surface 142 having a first diameter and a cylindrical outer surface 138 having a second diameter greater than the first diameter. A filter body 150 formed by the thin, spirally wound HDACM 114 is formed between the cylindrical inner surface 142 and the cylindrical outer surface 138. The filter body 150 includes adsorbent bound by polymer, with at least 70% (by weight) of the adsorbent being powdered activated carbon having a median particle size of less than 180 microns. In some embodiments, the median particle size of the powdered activated carbon is less than 100 microns or less than 50 microns. In some embodiments, the filter body 150 has a porosity in the range of 3%-15% by volume. Each spirally wound layer of the filter 110 has a thickness between 300-2000 microns (in some embodiments between 400-1000 microns) and has a carbon loading of 50 to 1000 g/m² (e.g., at least 200 g/m² , at least 250 g/m² ). The water inlet side of the filter 110 (which may be at the cylindrical inner surface 142 or the cylindrical outer surface 138) is, in some embodiments, unpolished such that the pore size at the water inlet side is in the range of 0.05-0.5 microns. The water outlet side of the filter, at the other of the cylindrical inner or outer surfaces 142, 138 (opposite the water inlet side) is polished such that the pore sizes are greater than at the water inlet side.

The water filter 110 shown in FIGS. 7A-7B as formed by the process detailed in FIGS. 1-6 has shown, via testing, to have a performance level of 6 mg/g (6 milligrams of chloroform adsorbed onto the filter 110 per gram of adsorbent (e.g., carbon)). Conventional carbon block filters, such as those manufactured via extrusion and compression molding, have a chloroform adsorption capacity of only approximately 3 mg/g (3 milligrams of chloroform adsorbed per gram of adsorbent). As such, the filter 110 and method of manufacturing the filter 110 provide a substantial increase in performance relative to those formed via conventional methods.

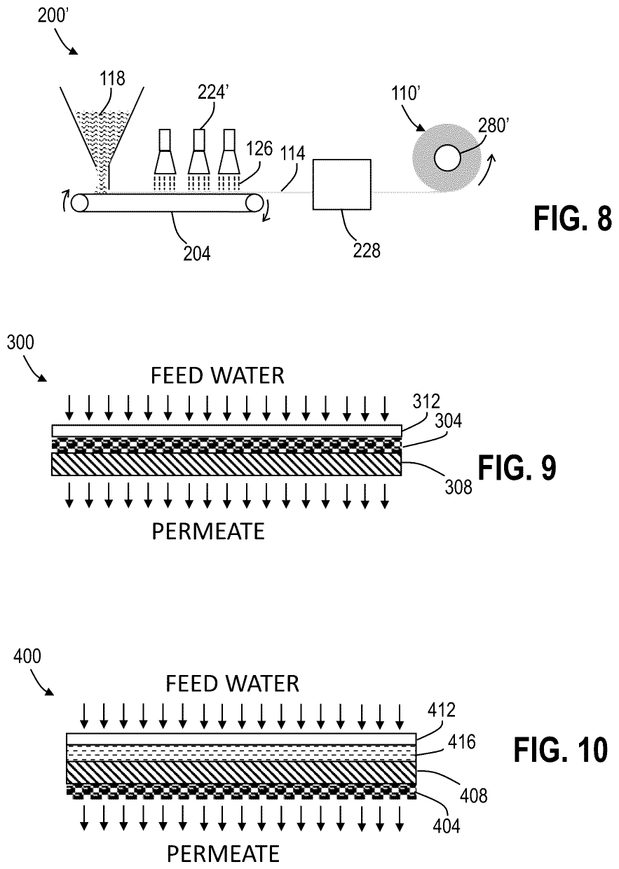

FIG. 8 illustrates an alternative manufacturing apparatus 200′ to the manufacturing apparatus 200 illustrated in FIG. 2. The apparatus 200′ is similar to that shown in FIG. 2 except as otherwise described. Rather than incorporating a bath tank, the apparatus includes a shower 224′ configured to spray a solvent 126 (e.g., water) onto the activated carbon solution 118 to perform a similar function as the bath tank 224. Additionally, as the activated carbon solution 118 does not pass through a bath tank, the substrate 122 can be omitted such that the activated carbon solution 118 rests directly on a continuous belt 204. The shower 224′ sprays the solvent 126 onto the activated carbon solution 118 to precipitate the polymer out of the solution 118, such that the polymer within the thin film coagulates, thereby adhering the activated carbon together and forming the high density activated carbon membrane 114 (HDACM). The HDACM 114 is then wrapped without a substrate onto the spool 280′ to form the filter 110′. While not shown in FIG. 8, the polishing step 106 may be provided after the drying oven 228.

FIGS. 9 and 10 illustrate reverse osmosis (RO) membranes 300, 400 having a thin film with adsorbent 304, 404 formed via the process described in FIGS. 1-6 and functioning as a support layer formed onto a support or fabric layer 308, 408. In the embodiment of FIG. 9, an active RO layer 312 is formed on top of the thin film having adsorbent 304. In the embodiment of FIG. 10, the active RO layer 412 is formed on top of a conventional support layer (i.e., without adsorbent) 416, and the thin film with adsorbent is formed on the opposite side of the support or fabric layer 408. The thin film with adsorbent 304, 404 acts as a post-filter for the permeate. FIG. 9 illustrates the thin film 304 as the support layer. FIG. 10 illustrates the thin film 404 on the back side of the support layer 408, in addition to a traditional porous layer 416 between the active layer 412 and the support layer 408.

Membranes, such as reverse osmosis (RO)/nanofiltration (NF) and RO/NF/ultrafiltration (UF) membranes, are used to remove a variety of contaminates from water, as the use of these membranes is more environmentally friendly than other traditional water treatment methods. Such contaminates include salts and/or volatile organic compounds (VOCs). RO/NF membranes are typically thin film composite (TFC) membranes and may include three layers: the base fabric layer 308, 408, the porous layer 304, 404, 416, and a top active layer 312, 412 (i.e., a desalination layer). The membranes illustrated in FIGS. 9-10 contain adsorbents within the porous layers 304, 404.

In particular, the membranes 300, 400 include the active layer 312, 412, the fabric layer 308, 408 and at least one porous layer 304, 404, 416. The porous layer 304, 404 contains at least one type of adsorbent. The adsorbent may be an adsorbent such as activated carbon, zeolite, active alumina, or a mixture of different adsorbents as described above with reference to FIGS. 1-8. When the membrane 300, 400 containing activated carbon is exposed to volatile organic compounds (VOC) in water, the VOCs are adsorbed by the adsorbent in the membrane, and thus removed from the feed water.

Various features of the disclosure are set forth in the following claims.

1. A method of making a water filter, comprising the steps of:
formulating a solution comprising a polymer, an adsorbent, and a first solvent, the polymer being soluble in the first solvent;
casting the solution onto a substrate to form a thin film;
dissolving the first solvent in a second solvent to precipitate the polymer out of solution;
removing the thin film from the substrate; and
rolling the thin film to form a cylindrical filter.

2. The method of claim 1, wherein the second solvent is water.

3. The method of claim 1, wherein a ratio, by weight, of the adsorbent to the polymer is at least 4:1.

4. The method of claim 1, wherein the adsorbent comprises powdered activated carbon (PAC) having a particle size of <180 μm.

5. The method of claim 4, wherein the PAC has an average particle size of <50 μm.

6. The method of claim 1, further comprising the step of drying the thin film to remove the second solvent prior to removing the thin film from the substrate.

7. The method of claim 1, further comprising the step of removing a top layer of at least a portion of the thin film prior to rolling the thin film to form the cylindrical filter.

8. The method of claim 7, wherein the top layer that is removed has a thickness in the range of 5 μm to 50 μm.

9. The method of claim 1, wherein the polymer is selected from the group consisting of polysulfone, polystyrene, polyether sulfone, polyvinylidene fluoride, and polyvinyl chloride.

10. The method of claim 1, wherein the first solvent is selected from the group consisting of n-n-dimethyl formamide, chloroform, dimethylacetamide, and n-methyl-2-pyrrolidone.

11.-20. (canceled)
